(19) United States
(12) Patent Application Publication
(10) Pub. No.: US 2026/0133057 A1
(43) Pub. Date: May 14, 2026

(54) ENCODER AND METHOD FOR DETERMINING A ROTATIONAL RELATIVE POSITION BETWEEN TWO COMPONENTS AND ROBOT HAVING SUCH AN ENCODER

(71) Applicant: Schaeffler Technologies AG & Co. KG, Herzogenaurach (DE)

(72) Inventor: Jochen Damerau, Tokyo (JP)

(73) Assignee: Schaeffler Technologies AG & Co. KG, Herzogenaurach (DE)

(21) Appl. No.: 19/118,957

(22) PCT Filed: Sep. 8, 2023
(86) PCT No.: PCT/DE2023/100667

§ 371 Date: Apr. 7, 2025

(30) Foreign Application Priority Data
Oct. 7, 2022 (DE) 10 2022 125 958.7

(51) Int. Cl. G01D 5/249; B25J 13/08

(52) U.S. Cl. CPC G01D 5/2492; B25J 13/088

(57) ABSTRACT

An encoder and a method for determining a rotational position of a first component relative to a second component that can be rotated relative thereto is provided. The encoder includes a first reading head, which is arranged on the second component, and a drive unit with a drive element that is driven in rotation relative to the first component, to which at least a first magnetic disc is fastened and which is designed to be arranged on the first component. The first magnetic disc has, on an end face facing the first reading head, at least one circumferential first track with a plurality of magnetic regions formed one behind the other in the circumferential direction of the first magnetic disc and having alternating magnetisation directions. The first reading head detects at least a first periodic pulse sequence.

### CROSS-REFERENCE TO RELATED APPLICATIONS

This application is the United States National Phase of International Application PCT/DE2023/100667, filed Sep. 8, 2023, which claims priority to German Application 10 2022 125 958.7, filed Oct. 7, 2022. The disclosures of the above applications are incorporated herein by reference.

### TECHNICAL FIELD

The disclosure relates to an encoder for determining a rotational position of a first component relative to a second component. Furthermore, the disclosure relates to a method for determining a rotational position of the first component relative to the second component with such an encoder. The disclosure further relates to a robot having such an encoder.

### BACKGROUND

Encoders, such as angle encoders, are an essential component of many mechatronic products. The term “encoder” is to be understood as a rotary sensor. One of the main applications is robotics, in which the kinematic state of a robot or a robot arm must be known at all times in order to control the robot effectively. In particular, encoders operatively arranged at the output of an actuator can significantly increase the precision of the robot because they measure the true angle, which is not affected by the elasticity of the actuator or other influences. However, the slowly rotating output of the transmission requires very high-resolution encoders in order to be able to measure even very small angle changes. In robotics and other applications, a high precision and resolution of angle measuring devices is advantageous because accurate knowledge of the kinematic state directly determines the precision and repeatability of the tool point movement, an important performance characteristic of a robot arm. The physical resolution of an angle encoder is limited by the size of the structures that can be created on the sensor and the resolution for effectively detecting these structures, such as the wavelength of light.

For example, DE 10 2016 202 792 A1 discloses a robot joint including a robot member, a drive gear rotatably mounted on the robot member and an output gear rotatably mounted on the robot member, a transmission device coupling the drive gear to the output gear for transmitting a drive torque, and a motor which drives the drive gear and has a motor shaft which is connected to the drive gear via a drive connection for introducing the drive torque. A safety clutch is provided and designed to disconnect the drive connection between the motor shaft and the output gear when a predetermined limit torque is exceeded and to restore the drive connection between the motor shaft and the output gear when there is a fall below the predetermined limit torque. In addition, a sensor device is provided and designed to detect the rotary angle position of the output gear. In order to be able to determine the exact position and direction of rotation of the joint itself even when the robot is moved externally in a passive manner or when the drive train slips, an output-side position measurement is used, which can be carried out simply or redundantly. For simple position measurement, an encoding disk can be connected to the output belt pulley. In the case of double measurement, another encoding disk must also be arranged on the middle belt pulley set. The lines on the encoding disk can be detected by a sensor during rotation.

### SUMMARY

The disclosure provides an encoder with improved resolution, a method for determining a rotational position of a first component relative to a second component, and a robot.

A first aspect of the disclosure provides an encoder for determining a rotational position of a first component relative to a second component which can be rotated relative thereto. The encoder includes at least one first reading head which is designed to be arranged on the second component, and a drive unit having a drive element which can be driven in rotation relative to the first component and to which at least one first magnetic disk is fastened and which is designed to be arranged on the first component. The at least first magnetic disk has, on an end face facing the first reading head, at least one circumferential first track having a plurality of magnetic regions which are formed one behind the other in the circumferential direction of the first magnetic disk and which have alternating magnetization directions, and the first reading head is designed to, during rotation of the at least first magnetic disk relative to the first component, detect at least a first periodic pulse sequence by measuring the magnetization directions along the first track, and the respective detected periodic pulse sequence can be compared with a reference pulse sequence with the same periodicity in order to determine at least a first phase difference between the respective detected periodic pulse sequence and the reference pulse sequence and to determine a rotational position of the first component relative to the second component on the basis of the at least first phase difference.

In this context, an encoder or rotary sensor is understood to be a rotational angle sensor, angle encoder or even an angular position sensor. Typical applications of rotary sensors in vehicles include steering angle sensors and wear-free rotary switches. Further applications in robotics include angle sensors for determining the direction of rotation and position of robot arm segments of a robot arm which are coupled to one another via a joint.

The first component and the second component are connected to one another in an articulated manner, and the second component may be rotated relative to the first component. A drive is provided which generates a drive power and transmits this, for example via a pre-transmission, to the second component in order to set a rotational relative position between the components. For this purpose, the drive is supported on the first component so that the second component can be rotated relative to the first component. In some examples, the first and second components are each designed as a shaft. The two components may be arranged concentrically.

In some implementations, the drive unit is a spindle drive, where the drive element is a spindle which is arranged on the first component and is arranged to be relatively rotatable. In some examples, the first component is arranged coaxially with respect to the spindle. The at least first magnetic disk is fastened to the spindle. The spindle can be driven in rotation together with the at least first magnetic disk at a constant rotational speed relative to the first component. Rotational speeds of 4000 to 15,000 revolutions per minute are conceivable. At the end face, the first magnetic disk has the first track with a plurality of magnetic or magnetized regions arranged one behind the other in the circumferential direction of the magnetic disk, each magnetic region having been magnetized or formatted with a specific magnetization direction.

The respective magnetic disk is a magnetic turntable with at least one track on its end face facing the corresponding reading head. The respective track may be circular, i.e. completely circumferential, on the end face of the respective magnetic disk. In some examples, the first track of the first magnetic disk is arranged in the region of the outer diameter of the at least first magnetic disk. The further the track is arranged outward in the radial direction on the respective magnetic disk, the larger the diameter of the respective track and the greater the number of magnetic regions and, accordingly, the amount of data that can be stored or encoded on the track. It is conceivable to store data of over 20 million bits on such a track, which corresponds to a physical resolution of over 24 bits. Each of the more than 20 million bits is assigned to one of the magnetic regions. In other words, each magnetic region forms a bit by its magnetization direction. The higher the number of bits or magnetic regions, the more precisely the angle can be measured when the second component is rotated relative to the first component. The at least first reading head is designed to read bit patterns of more than 24 bits from the track on the magnetic disk at a rotational speed of the respective magnetic disk of at least 4000 revolutions per minute. Thus, the first reading head interacts with the magnetic regions that form the track on the first magnetic disk.

The individual bits are encoded by magnetizing the magnetic regions in a specific magnetization direction along the corresponding track on the respective magnetic disk. A change in the magnetization direction usually means a “1”, and the same magnetization direction of two successive magnetic regions decodes a “0”. The at least first track may be completely preformatted with “1”. In other words, two magnetic regions adjacent in the direction of the track never have the same magnetization direction. Thus, the magnetization direction changes in each successive magnetic region. This enables the highest possible angular resolution of the rotary sensor. In this sense, the magnetic regions of the respective track have alternating magnetization directions in the circumferential direction of the magnetic disk.

Typically, the track is encoded in the longitudinal direction. The longitudinal direction means that the magnetization directions of the magnetic regions are each oriented in the tangential direction of the respective magnetic disk. Alternatively, the magnetic regions can be encoded in perpendicular recording, which increases the data density or the number of bits over the circumference. In perpendicular recording, the magnetization directions of the magnetic regions are each oriented axially with respect to the axis of rotation of the respective magnetic disk.

In some implementations, the respective track contains a special guide structure so that the respective reading head reliably follows the track without losing it. The respective reading head floats above the respective magnetic disk on an air cushion or helium cushion, which is generated by the rotating magnetic disk.

The respective track on the magnetic disk is to be understood as a data track. It is conceivable to form a plurality of data tracks on the end face of the corresponding magnetic disk facing the reading head. For example, lower-resolution tracks may be formed radially inside the first track. Each track can be assigned a reading head, with the tracks being read simultaneously during rotation of the respective magnetic disk. This allows an absolute adjustment angle between the first and second component to be determined. Thus, an absolute angle encoder can be realized in this way.

The first magnetic disk is connected to the first component via the drive element, preferably via the spindle of the spindle drive. The first component can be a first robot arm segment, which can be connected in an articulated manner to a second robot arm segment. The drive element drives the respective magnetic disk at a constant speed, and the speed creates the air or helium cushion between the respective magnetic disk and the reading head. While the respective magnetic disk is rotating, the corresponding reading head floats on the air or helium cushion. The at least first reading head is fastened to the second component. After the respective magnetic disk has reached its operating speed, the corresponding reading head is switched on to follow the track on the end face of the turntable. The second component can be a housing or a second robot arm segment.

In some implementations, the respective reading head is arranged pivotably on the second component. The respective reading head can be pivoted at least between one parking position and at least one operating position. The pivoting arrangement is advantageous because the respective reading head can only be pivoted into the respective operating position when the respective magnetic disk has reached its operating speed. In addition, the respective reading head can better follow the respective track, which does not necessarily have to be designed to be exactly circular or concentric.

The respective reading head receives a voltage signal by reading the respective data track and measuring the respective magnetic field of the magnetic regions while it glides or floats along the at least first track on the rotating magnetic disk. The second component is not adjusted relative to the first component. This signal is to be understood as a periodic pulse sequence.

Subsequently, a reference signal or a reference pulse sequence is generated and compared with the periodic pulse sequence. The reference pulse sequence can be a synthetic reference signal that can be generated by a processor unit, also known as a CPU, or by a signal generator. This reference signal resembles the periodic pulse sequence that the respective reading head has measured under static conditions. In some examples, the reference pulse sequence has exactly the same frequency, i.e. the same periodicity.

In some implementations, the reference pulse sequence can be or is provided by a processor unit. The processor unit may include a synthetic signal generator or receive the reference signal from a separate synthetic signal generator. Consequently, the reference pulse sequence is a synthetic reference pulse sequence. A synthetic reference pulse sequence is therefore not measured, but rather generated and provided in a computer-assisted manner, and the encoding of the respective track is known and is used to generate the reference pulse sequence.

Alternatively, the reference pulse sequence can be provided or is provided by a signal generator comprising a second magnetic disk also fastened to the drive element of the drive unit and a second reading head which is designed to be arranged on the first component, the second magnetic disk having, on an end face facing the second reading head, at least one circumferential second track with a plurality of magnetic regions which are formed one behind the other in the circumferential direction of the second magnetic disk and which have alternating magnetization directions, the second track on the second magnetic disk being designed to be identical to the first track on the first magnetic disk. Therefore, the reference signal is not a synthetic signal, but is generated by the second magnetic disk, which is mounted together with the first magnetic disk on the same drive element and has the same divisions, i.e. magnetic regions, and formats, i.e. changes in magnetization direction, as the first magnetic disk. The reference signal is the voltage measured by the second reading head on the first component, said voltage rotating at exactly the same speed as the first magnetic disk.

The periodic pulse sequence detected by the at least first respective reading head is compared with the reference pulse sequence with the same periodicity in order to determine the at least first phase difference between the respective detected periodic pulse sequence and the reference pulse sequence. This can be done by Fourier transformation or cross-correlation of the signals. Based on at least the first phase difference, a rotational position of the first component relative to the second component can be determined. If the first component is fixed relative to the second component, the phase difference remains unchanged. In this sense, the first phase difference can be determined if the second component is fixed relative to the first component.

When the first component rotates with respect to the second component, or vice versa, the phase difference changes. Depending on the resolution with which this phase difference can be resolved, it increases the overall resolution of the encoder proposed here. For example, if the phase difference is resolvable in 64 steps, an overall resolution of 30 bits or 90 nanoarcseconds can be obtained. This significantly exceeds the resolution of currently known encoders. In this sense, further phase differences can be determined or are determined while the second component is rotated relative to the first component. In other words, a change in the phase difference is tracked.

The total angular difference between the components that can be rotated relative to each other can be calculated by counting the zero crossings (taking into account the direction/sign) of the respective phase difference and by multiplying it by the magnitude of the magnetic angular range. Finally, the actual phase difference can also be multiplied by the magnitude of the magnetic angular range and added.

Another aspect of the disclosure provides a method for determining a rotational position of a first component relative to a second component. The method may be carried out by way of an encoder according to the first aspect of the disclosure. At least a first periodic pulse sequence is detected by way of the first reading head during rotation of the at least first magnetic disk relative to the first component by measuring the magnetization directions along the first track, and the respective detected periodic pulse sequence is compared with a reference pulse sequence with the same periodicity in order to determine at least a first phase difference between the respective detected periodic pulse sequence and the reference pulse sequence and to determine a rotational position of the first component relative to the second component on the basis of the at least first phase difference.

Another aspect of the disclosure provides a robot that includes a first robot arm segment and a second robot arm segment operatively connected thereto via a joint. An encoder according to the first aspect of the disclosure is operatively arranged in the joint. The joint is a robot joint that connects at least two segments of a robot arm. In addition to the encoder, at least one actuator and/or sensor system is provided in the robot joint to move the robot arm or to detect a current position of the robot arm in space and/or a load on the robot arm.

The above definitions as well as explanations of technical effects, advantages and advantageous examples of the respective encoder according to the first aspect of the disclosure also apply, mutatis mutandis, to the method according to the second aspect of the disclosure and to the robot according to the third aspect of the invention, and vice versa.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a highly schematic view of an exemplary robot arm of a robot;

FIG. 2 shows a schematic longitudinal section view to illustrate the structure of an exemplary encoder;

FIG. 3 shows a highly schematic view of a first magnetic disk of the encoder according to FIG. 2.

FIG. 4 shows a highly schematic representation of the first magnetic disk according to FIG. 3 to illustrate a first track with a plurality of magnetic regions and a periodic pulse sequence measured by a first reading head on the basis of the magnetization directions of the magnetic regions;

FIG. 5 shows a schematic representation of the measured periodic pulse sequence according to FIG. 4 and a reference pulse sequence to illustrate a phase difference determination; and

FIG. 6 shows a schematic longitudinal section view to illustrate the structure of an encoder according to a second example.

Like reference symbols in the various drawings indicate like elements.

### DETAILED DESCRIPTION

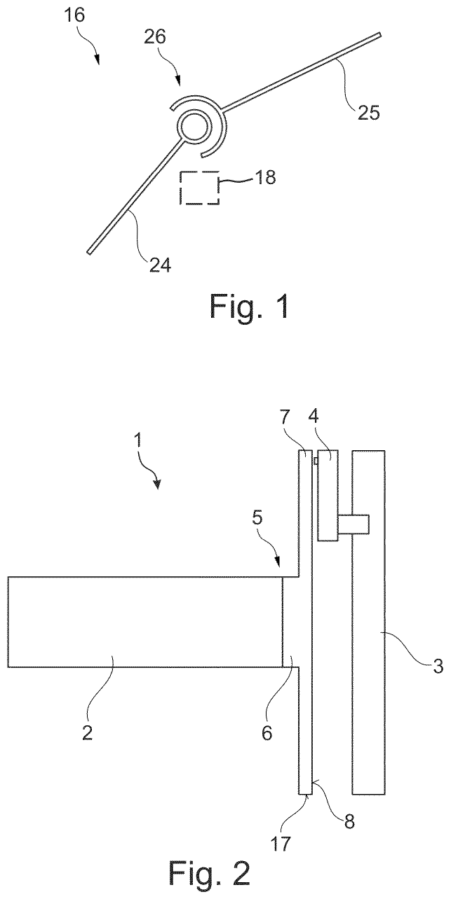

FIG. 1 shows a robot arm of a robot 16—only partially shown here—in a highly schematic and simplified manner. In the present case, the robot arm has a first robot arm segment 24 and a second robot arm segment 25, which are connected to one another in an articulated manner via a joint 26. For example, a drive train is arranged and supported on the first robot arm segment 24, including a drive (not shown here), the drive power of which can be transferred to the second robot arm segment 25 via a transmission stage (also not shown here). The drive train is understood to be the actuator of the robot arm. The first component 2 described below can be the output element, for example the output shaft of the transmission stage, which is operatively connected to the second component 3, while the second component 3 can be directly fastened to the second robot arm segment 25 or can be the second robot arm segment 25 itself.

An encoder 1 according to FIG. 2 is operatively arranged in the joint 26 between the two robot arm segments 24, 25. The encoder 1 is designed to determine a rotational position of the first component 2 relative to the second component 3 which can be rotated relative to it. The encoder 1 in the present case includes a first reading head 4 and a drive unit 5 designed as a spindle drive with a drive element 6 that can be driven in rotation relative to the first component 2. The drive element 6 of the drive unit 5 is here a spindle which is arranged on the first component 2 and can rotate relative thereto at a constant rotational speed of at least 4000 revolutions per minute. A first magnetic disk 7 is fastened to the spindle and can rotate accordingly at the same rotational speed. The first reading head 4 is arranged on the second component 3 so as to be pivotable from a parking position into an operating position and vice versa.

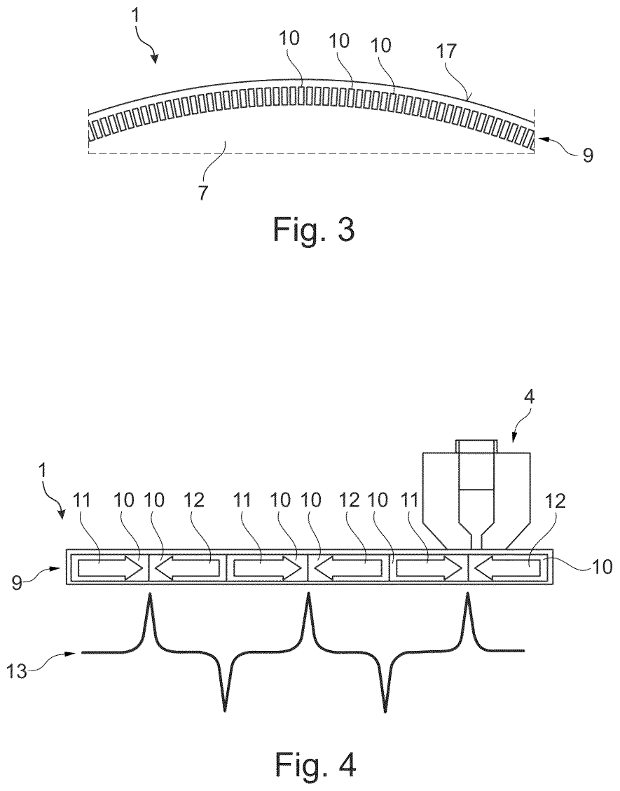

The first magnetic disk 7 has, on an end face 8 facing the first reading head 4, at least one circumferential first track 9 with a plurality of magnetic regions 10 formed uniformly one behind the other in the circumferential direction of the first magnetic disk 7. The end face 8 of the first magnetic disk 7 is shown as an example in FIG. 3. It can be clearly seen here that the track 9 is formed in the region of the outer diameter 17 of the first magnetic disk 7 in order to realize the highest possible number of magnetic regions 10.

The magnetic regions 10 are preformatted, as shown in FIG. 4. They have alternating magnetization directions 11, 12 in the longitudinal direction of the track 9 and in the circumferential direction of the first magnetic disk 7. In other words, the magnetization direction 11, 12 changes in each successive magnetic region 10. Each magnetic region 10 corresponds to one bit. The bits are encoded by magnetizing the magnetic regions 10 along the track 9 on the first magnetic disk. This is illustrated in a section of track 9 in FIG. 4 by the arrows pointing left and right.

After the spindle with the first magnetic disk 7 has reached the desired operating speed, the first reading head 4 can be pivoted from a parking position into an operating position, where the first reading head 4 can follow the first track 9 to measure the magnetic fields of the magnetic regions 10 in order to form a first periodic pulse sequence 13 therefrom. In this context, FIG. 4 shows, below the track 9, a first periodic pulse sequence 13 which is detected by the first reading head 4 detecting the magnetic fields of the magnetic regions 10 and the changes in the magnetization directions 11, 12. The magnetic regions 10 are encoded here in the longitudinal direction of the track 9. A change in the magnetization direction 11 or 12 usually means a “1”, and the same magnetization direction of two successive magnetic regions 10 decodes a “0”. Since the track 9 is preformatted in such a way that the magnetization direction 11, 12 changes in each successive magnetic region 10, the value “1” is output for each subsequent magnetic region or each subsequent bit. The first reading head 4 is therefore designed to detect the first periodic pulse sequence 13 by measuring the magnetization directions 11, 12 along the first track 9 when the at least first magnetic disk 7 rotates relative to the first component 2. This happens statically, i.e. while the first and second components 2, 3 are not rotated relative to each other or when the components 2, 3 are stationary.

In addition to the first periodic pulse sequence 13, a synthetic reference pulse sequence 14 is generated in this case and compared with the periodic pulse sequence 13. The reference pulse sequence is therefore a synthetic reference signal that is generated by a processor unit (not shown here) or by a signal generator (also not shown here). This reference signal is similar to the first periodic pulse sequence 13 measured by the first reading head 4 under static conditions. In some examples, the reference pulse sequence 14 has exactly the same frequency, i.e. the same periodicity, as the first periodic pulse sequence 13.

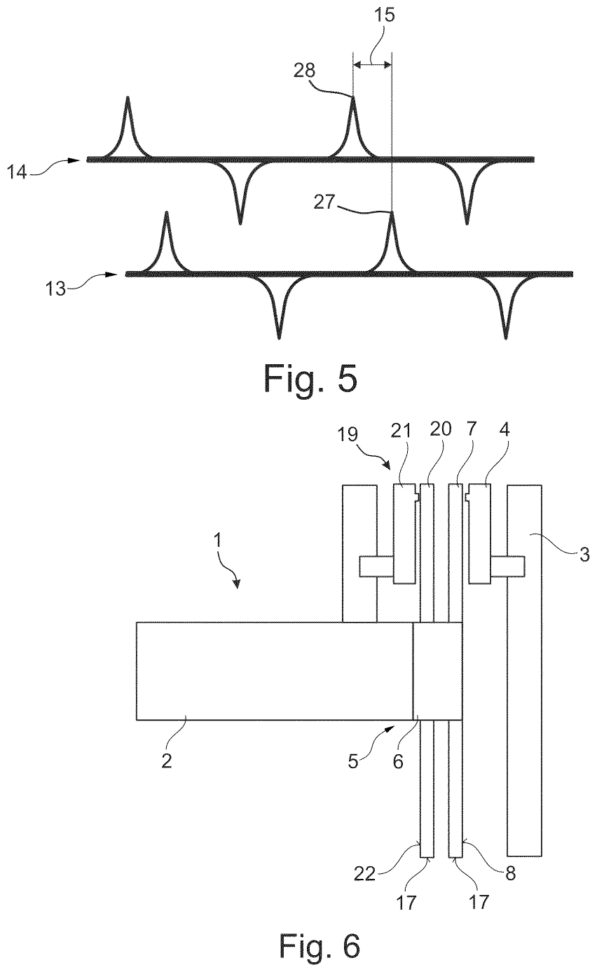

By comparing the detected first periodic pulse sequence 13 with the reference pulse sequence 14, a phase difference 15 between the detected periodic pulse sequence 13 and the reference pulse sequence 14 is determined, which is shown by way of example in FIG. 5. While the frequencies of the periodic pulse sequence 13 and the reference pulse sequence 14 are identical, a phase difference 15 between the pulse sequences is calculated, on the basis of which conclusions can be drawn about a rotational position of the first component 2 relative to the second component 3. The phase difference 15 here is the distance between an amplitude 27 of the periodic pulse sequence 13 and a corresponding amplitude 28 of the reference pulse sequence. The phase difference 15 is shown as a double arrow with a base and two tips.

When the second component 3 is adjusted, such as rotated, relative to the first component 2, the phase difference 15 changes. The phase difference 15 therefore becomes larger or smaller. Thus, a first phase difference 15 is determined when the second component 3 is fixed relative to the first component 2, and further phase differences are determined while the second component 3 is rotated relative to the first component 2.

The total angular difference is calculated by counting the zero crossings (taking into account the direction/sign) of the phase difference 15 and multiplying by the magnitude of the magnetic angular range. The actual phase difference 15 is multiplied by the magnitude of the magnetic angular range and added.

As shown in FIG. 6, a real reference pulse sequence can be determined instead of a synthetic reference pulse sequence. For this purpose, a signal generator 19 is provided, including a second magnetic disk 20, which is also fastened to the drive element 6 of the drive unit 5, and a second reading head 21. The second magnetic disk 20 is fastened together with the first magnetic disk 7 to the spindle or the drive element 6 so that they always rotate at the same rotational speed. In the present case, the magnetic disks 7, 20 are arranged axially spaced from one another. However, they can also come to bear against one another.

The second magnetic disk 20 has, on an end face 22 facing the second reading head 21, at least one circumferential second track 9 having a plurality of magnetic regions 10 which are formed one behind the other in the circumferential direction of the second magnetic disk 20 and which have alternating magnetization directions 11, 12. The second track 9 on the second magnetic disk 20 is designed to be identical to the first track 9 on the first magnetic disk 7 in order to be able to compare the reference signal with the signal measured by the first reading head 4. Otherwise, the encoder 1 is identical to the example shown in FIGS. 2 to 5. The aforesaid in respect of the first magnetic disk 7 applies analogously to the second magnetic disk 20. The aforesaid in respect of the first reading head 4 applies analogously to the second reading head 21. Furthermore, the aforesaid in respect of the first track 9 applies analogously to the second track 9. FIGS. 3 to 5 are therefore applicable analogously to the example shown in FIG. 6.

By operatively arranging the encoder 1 at the output of the transmission stage, the precision of the robot 16 can be significantly increased since a true angle between the two components 2, 3 can be measured which is not affected by the elasticity of the drive train or other influences.

A number of implementations have been described. Nevertheless, it will be understood that various modifications may be made without departing from the spirit and scope of the disclosure. Accordingly, other implementations are within the scope of the following claims.

### REFERENCE NUMERALS

1 Encoder
2 First component
3 Second component
4 First reading head
5 Drive unit
6 Drive element
7 First magnetic disk
8 End face of the first magnetic disk
9 First track
10 Magnetic region
11 First magnetization direction
12 Second magnetization direction
13 First periodic pulse sequence
14 Reference pulse sequence
15 First phase difference
16 Robot
17 Outer diameter of the first magnetic disk
18 Processor unit
19 Signal generator
20 Second magnetic disk
21 Second reading head
22 End face of the second magnetic disk
9 Second track
24 First robot arm segment
25 Second robot arm segment
26 Joint
27 Amplitude of the periodic pulse sequence
28 Amplitude of the reference pulse sequence

1. An encoder for determining a rotational position of a first component relative to a second component which can be rotated relative thereto, the encoder comprising:
at least one first reading head arranged on the second component; and
a drive unit having a drive element which is driven in rotation relative to the first component and to which at least one first magnetic disk is fastened, the drive unit is arranged on the first component, wherein:
the at least first magnetic disk has, on an end face facing the first reading head, at least one circumferential first track having a plurality of magnetic regions formed one behind the other in the circumferential direction of the first magnetic disk and have alternating magnetization directions,
the first reading head, during rotation of the at least first magnetic disk relative to the first component, detects at least a first periodic pulse sequence by measuring the magnetization directions along the first track, and
the respective detected periodic pulse sequence is compared with a reference pulse sequence with the same periodicity to determine at least a first phase difference between the respective detected periodic pulse sequence and the reference pulse sequence and to determine a rotational position of the first component relative to the second component based on the at least first phase difference.

2. The encoder of claim 1, wherein the first phase difference is determined when the second component is fixed relative to the first component.

3. The encoder of claim 1, wherein further phase differences are determined while the second component is rotated relative to the first component.

4. The encoder of claim 1, wherein the at least first magnetic disk is circular, the first track is arranged in the region of an outer diameter of the first magnetic disk.

5. The encoder of claim 1, wherein the reference pulse sequence is provided by a processor unit.

6. The encoder of claim 1, wherein the reference pulse sequence is provided by a signal generator, comprising a second magnetic disk also fastened to the drive element of the drive unit and a second reading head which is arranged on the first component, the second magnetic disk comprising, on an end face facing the second reading head, at least one circumferential second track having a plurality of magnetic regions which are formed one behind the other in the circumferential direction of the second magnetic disk and which have alternating magnetization directions the second track on the second magnetic disk is identical to the first track on the first magnetic disk.

7. A method for determining a rotational position of a first component relative to a second component by an encoder, the encoder comprising at least one first reading head arranged on the second component, and a drive unit having a drive element driven in rotation relative to the first component and to which at least one first magnetic disk is fastened and which is arranged on the first component, wherein the at least first magnetic disk has, on an end face facing the first reading head, at least one circumferential first track having a plurality of magnetic regions which are formed one behind the other in the circumferential direction of the first magnetic disk and which have alternating magnetization directions the method comprising:
during rotation of the at least first magnetic disk relative to the first component. measuring, at the first reading head, the magnetization directions along the first track;
detecting, at the first reading head, at least a first periodic pulse sequence based on the measured magnetization directions along the first track, and
comparing the respective detected periodic pulse sequence with a reference pulse sequence with the same periodicity;
determining at least a first phase difference between the respective detected periodic pulse sequence and the reference pulse sequence based on the comparison; and
determining a rotational position of the first component relative to the second component based on the at least first phase difference.

8. The method according to claim 7, wherein the reference pulse sequence is provided by a processor unit.

9. The method according to claim 7, wherein the reference pulse sequence is provided by a signal generator, comprising a second magnetic disk which is also fastened to the drive element the drive unit and a second reading head which is designed to be arranged on the first component, wherein the second magnetic disk has, on an end face facing the second reading head, at least one circumferential second track having a plurality of magnetic regions which are formed one behind the other in the circumferential direction of the second magnetic disk and which have alternating magnetization directions and the second track on the second magnetic disk is designed to be identical to the first track on the first magnetic disk.

10. A robot comprising:
a first robot arm segment;
a second robot arm segment operatively connected thereto via a joint; and
an encoder of claim 1 operatively arranged in the joint.
